(19) United States
(12) Patent Application Publication
(10) Pub. No.: US 2007/0014262 A1
(43) Pub. Date: Jan. 18, 2007

(54) Method for handling over a call involving a mobile node in a macromobility situation in an IP communication network using hierarchical routing

(75) Inventors: Laurence Gras, Bures Sur Yvette (FR); Jean-Pierre Rombeaut, Maubeuge (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/476,804

(22) Filed: Jun. 29, 2006

(30) Foreign Application Priority Data
Jun. 30, 2005 (FR) 0551833

(51) Int. Cl. H04L 12/56

(52) U.S. Cl. 370/331; 370/389

(57) ABSTRACT

A call handover method for an Internet Protocol (IP) communication network using hierarchical routing comprising first and second mobility anchor points (P1, P2) connected to respective first and second access routers (R1, R2) and a home agent (EA) of a mobile first node (T1) communicating with a second node (T2) consists in, when the mobile first node (T1) detects the second access router (R2): i) determining the address prefix of the second access router (R2) in order to communicate it to the mobile first node (T1) in order for the latter to construct additional local and regional care-of addresses, ii) communicating the additional local care-of address to the first anchor point (P1) in order for it to set up a temporary tunnel (TU) to the second access router (R2) in order to forward packets addressed to the mobile first node (T1) to the second access router (R2), iii) connecting the mobile first node (T1) to the second access router (R2) in order to forward to it the packets received via the temporary tunnel (TU), and iv) communicating the additional local and regional care-of addresses of the mobile first node (Ti) to the second anchor point (P2) and to the home agent equipment (EA) in order for them to substitute them for the previous ones.

### CROSS-REFERENCE TO RELATED APPLICATIONS

This application is based on French Patent Application No. 0551833 filed 30/06/2005, the disclosure of which is hereby incorporated by reference thereto in its entirety, and the priority of which is hereby claimed under 35 U.S.C. § 119.

### BACKGROUND OF THE INVENTION

1. Field of the Invention

The invention relates to Internet Protocol (IP) communication networks using hierarchical routing and more precisely handover (call transfer) between access equipments of these networks involving at least one mobile (communication) equipment.

In the present context the expression “IP network” refers to a federation of subsets of IP networks (or IP subnetworks) interconnected by access equipments forming nodes, such as access routers.

In the present context, the expression “IP network using hierarchical routing” refers to an IP network in which calls between a mobile equipment (or node) and a communication equipment are effected via an agent equipment providing the home agent (or native) function for the mobile equipment, for example a home (or native) router, a mobility anchor point (MAP), for example a router, and a radio access equipment, for example an access router.

In the present context, the expression “mobile communication equipment” and the expression “mobile node” refer to any mobile (or portable) radio communication equipment (referred to hereinafter as a mobile equipment) capable of connecting to its home (sub)network (subnet) (or native subnetwork) or other subnetworks, referred to as remote (or external or foreign) subnetworks or visited networks, in order to exchange data in the form of signals with another communication equipment or with a subnetwork, for example, mobile telephones, laptop computers or personal digital assistants (PDA) equipped with a communication module.

2. Description of the Prior Art

Each mobile equipment that connects to an IP network has an IP home address (or IP native or permanent address) that corresponds to the prefix of the home (sub)network to which it is usually connected. When a mobile equipment is connected to its home network, data packets (or datagrams) sent to it are sent directly to its IP home address using a standard hop-by-hop type routing protocol. When the mobile equipment is roaming and wishes to connect to a remote (or external) subnetwork, it must configure itself with local and regional care-of (or complementary) addresses, known as care-of addresses, constructed from an address prefix supplied by the IP network, for example by means of a standard IPv6 mechanism, such as stateful or stateless autoconfiguration. These care-of addresses must be associated with the IP home address at the time of a binding update procedure effected between the mobile equipment and its home agent.

The person skilled in the art knows that there exist in the IP networks cited above IP mobility protocols, for example MIPv6, for ensuring that a mobile equipment can be contacted at any time and for ensuring the continuity of mobile equipment calls in progress, in particular during phases of transfer (handover) between access routers. Thus these protocols enable mobile equipments to maintain their connection to the Internet during handover and to continue to communicate with other equipments after changing their access (or attachment) point. However, they necessitate protocol operations and exchanges of signaling that introduce a phase during which the mobile equipment is no longer able to send or receive data packets (or datagrams).

A fast version F-HMIPv6 (Fast Handover for Hierarchical MIPv6) of Hierarchical MIPv6 has been proposed (in the form of an IETF draft) to limit the duration of this phase in which it is impossible to exchange packets, but only for handover between first and second access equipments connected to the same mobility anchor point, i.e. micromobility situations (in which mobility is limited to a single side (or anchor point) and is therefore characterized by local movements). It is therefore not applicable to handovers between first and second access equipments connected to first and second mobility anchor points, respectively, i.e. macromobility situations.

Thus an object of the invention is to remedy the drawback cited above.

### SUMMARY OF THE INVENTION

To this end the invention proposes a method of handing over a call involving at least one mobile equipment between radio access equipments connected to different mobility anchor equipments (or points) themselves connected to a home agent equipment providing the home (or native) agent function in an Internet Protocol (IP) communication network using hierarchical routing.

This method consists in effecting the following combination of steps each time a mobile first equipment has set up an IP call to a second communication equipment via the home agent equipment of the mobile first equipment, a first anchor point and a first radio access equipment, and when the mobile first equipment when roaming detects a second radio access equipment connected to a second anchor point itself connected to the home agent equipment:

i) determining the address prefix of the second access equipment in order to communicate it to the mobile first equipment in order for the latter to construct additional (or complementary) local and regional care-of addresses from it,

ii) communicating the additional local care-of address to the first anchor point in order for it to set up a temporary tunnel to the second access equipment or the second anchor point in order to forward packets addressed to the mobile first equipment to the second access equipment,

iii) connecting the mobile first equipment to the second access equipment in order to send it the received packets via the temporary tunnel, and

iv) communicating the additional local and regional care-of addresses of the mobile first equipment to the second anchor point and then communicating the additional regional care-of address of the mobile first equipment to the home agent equipment in order for the latter to substitute it for the previous one.

The method of the invention can have other features and in particular, separately or in combination:
in the step i) the mobile first equipment may determine the network identifier of the second access equipment and then communicate that network identifier to the first anchor point in order for the latter to determine the associated IP global address of the second access equipment from a server of the network and the address prefix of the second access equipment from the latter;
in the step i), before the mobile first equipment communicates the network identifier of the second access equipment to the first anchor point, the mobile first equipment may inform the first access equipment that it wishes to handover the call to the second access equipment designated by its network identifier, after which the first access equipment may inform the second access equipment of this handover requirement (this exchange procedure relates to radio technology but the invention can support variants of these exchanges in which only the identifier of the second access equipment needs to be communicated to the mobile equipment;
in the step i) the mobile first equipment may construct its additional local and regional care-of addresses by means of a stateless autoconfiguration procedure;
in the step ii) the mobile first equipment may communicate its additional local care-of address to the first anchor point by means of a Fast Binding Update type message;
in the step ii) the first anchor point and the second access equipment or the second anchor point may set up the temporary tunnel by means of a handover procedure;
in the step ii) the first anchor point may send to the mobile first equipment a fast binding acknowledgement type message when the temporary tunnel has been set up;
in the case of a WiMAX type radio access technology, in the step iii) the mobile first equipment may connect to the second access equipment by means of a network re-entry procedure; other procedures may be used, depending on the radio technology of the access network;
in the step iv) the mobile first equipment may communicate its additional local and regional care-of addresses to the second anchor point by means of a local binding update type message after which the second anchor point sends to the mobile first equipment a binding acknowledgement message after updating the local and regional care-of addresses of the mobile first equipment to the additional local and regional care-of addresses;
in the step iv) the mobile first equipment may communicate its additional regional care-of address to the home agent equipment by means of a Binding Update message, after which the home agent equipment sends to the mobile first equipment a Binding Acknowledgement message after updating the regional care-of address of the mobile first equipment to the additional regional care-of address.

The invention also proposes a mobility anchor point adapted to implement a portion of a handover method of the above type.

The invention is particularly well adapted to IPv6 (IP version number 6) type networks. However, it relates equally to IPv4 type networks supporting hierarchical routing, i.e. having a home agent, intermediate routers having a double function of relay agent for the home network and home agent for a local access network (functions equivalent to those of an IPv6 mobility anchor point), and access routers having a relay agent function for the local access network. In IPv4 there is a tunnel between the home agent and an intermediate router and a tunnel between the intermediate router and an access router, the latter tunnel being modifiable during handover as in the case IPv6.

Other features and advantages of the invention will become apparent on reading the following detailed description and examining the appended drawings.

### BRIEF DESCRIPTION OF THE DRAWINGS

FIG. 1 is a diagram of a portion of an IP network of the invention using hierarchical routing.

FIG. 2 is a diagram of the main operations implementing an example of a handover method of the invention in the IP network using hierarchical routing shown in FIG. 1.

### DETAILED DESCRIPTION OF THE PREFERRED EMBODIMENT

The appended drawings may not only constitute part of the description of the invention but also, if necessary, contribute to defining the invention.

An object of the invention is to shorten the phase during which a mobile communication equipment (or mobile node) is no longer able to send or receive data packets during handover between radio access equipments connected (or attached) to mobility anchor equipments (or points), which may be different, in an Internet Protocol (IP) communication network using hierarchical routing.

An IPv6 type IP network is considered hereinafter by way of nonlimiting example that supports the HMIPv6 (Hierarchical Mobile IPv6) mobility management protocol, like its network equipments and the mobile communication equipments (or mobile nodes) that can connect to it. However, the invention applies equally to IPv4 type IP networks.

The mobile communication equipments (referred to hereinafter as mobile equipments (or nodes)) considered hereinafter by way of nonlimiting example are personal digital assistants (PDA) equipped with a communication module, for example of the WiFi or WiMAX—IEEE 802.1x type. However, the invention is not limited to this type of mobile equipment. It relates to any type of mobile (or portable) radio communication equipment capable of connecting to its home (sub)network (or native subnetwork) or to other remote subnetworks (or external subnetworks or visited networks) in order to exchange data in the form of signals with another (fixed or mobile) communication equipment or with a subnetwork, for example a mobile telephone, a router or a laptop computer equipped with a communication module.

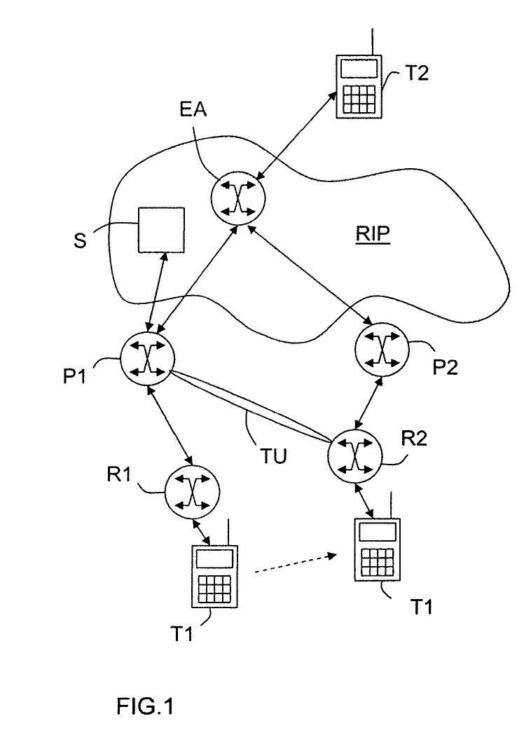

An IP network using hierarchical routing that can implement the handover method of the invention is described briefly first with reference to FIG. 1.

An IP network may be considered as a federation of subsets of IP networks (or IP subnetworks), here represented by the balloon labeled RIP and generally comprising a main subnetwork (for example a home (or native) network) of at least one mobile node T1 to which other subnetworks (or access networks) are connected.

In the present context, the expression “home (or native) network” refers to the subnetwork to which a mobile node T1 is usually connected, i.e. the subnetwork on which it has an IP home (or native) address that corresponds to its prefix.

Each mobile node is associated with a home agent equipment EA constituting its home agent, for example a router, belonging to its home network. The IP home address of a mobile node is stored by its home agent. The home agent equipment EA generally stores all the position (and location) information in respect of the mobile node associated with it, i.e. the mobility data concerning that node, and provides a place of transit for datagrams that must be transmitted to it when it is connected to a remote IP subnetwork (or visited network) other than its home network (as is the case in the FIG. 1 example).

The stored mobility data may include what the person skilled in the art calls local and regional IP care-of addresses (or complementary addresses or care-of addresses. These IP local care-of address (LCoA) and IP regional care-of address (RCoA) are unicast type routing addresses used respectively by the access router R1 (to which a mobile node T1 is temporarily connected) and the (mobility) anchor point P1 (to which the access router R1 is connected and which is connected to the home agent EA of the mobile node T1) to contact said mobile node T1. The home agent knows only the regional care-of address (RCoA) of each mobile node T1 associated with it.

The IP local care-of addresses (LCoA) and IP regional care-of addresses (RCoA) are determined by the mobile node T1 from the (IP) address prefix of the access router to which it is connected, for example by means of a standard IPv6 mechanism such as a stateful or stateless autoconfiguration. When a mobile node T1 is connected to an access router R1 of a remote subnetwork, it must inform its home agent EA in order for it to store its regional care-of IP address RCoA in corresponding relationship to its IP home address. To do this it uses a binding update procedure managed by the mobility protocol (MIPv6). Using this IP regional care-of address RCoA, the home agent EA is able to send a mobile node T1 associated with it datagrams that a calling node T2 has sent to its IP home address. More precisely, each packet sent to the IP home address of a mobile node T1 temporarily connected to a remote subnetwork is intercepted by its home agent EA and then forwarded via a tunnel passing through the anchor point P1 to which its access router R1 is connected and through said access router R1 to said mobile node T1 at the IP regional care-of address RCoA associated (in its database) with its IP home address.

The invention proposes a handover method involving a mobile first node T1 and a second node T2 (which may also be a mobile node) between a first access router R1 to which the mobile first node T1 is temporarily connected and which is connected to a first anchor point P1 itself connected to the home agent EA of the mobile first node T1 and a second access router R2 to which the mobile first node T1 is directed and which is connected to a second anchor point P2 itself connected to the home agent EA of the mobile first node T2.

This method can be used in an IP network supporting RIP hierarchical routing, on the one hand when the mobile first node T1 has set up an IP call with the second node T2 via its home agent EA, the first anchor point P1 and the first access equipment R1 and on the other hand when the mobile first node T1 is roaming and has detected the second access equipment R2.

At this stage, the mobile first node T1 is configured with a local care-of address LCoA-1 and a regional care-of address RCoA-1. Moreover, the regional care-of address RCoA-1 is on the one hand stored in the database of the home agent EA in corresponding relationship to the IP home address and on the other hand known to the first anchor point P1. Moreover, the local care-of address LCoA-1 is known to the first access router R1 and to the anchor point P1 (where it is stored in corresponding relationship to the regional care-of address RCoA-1).

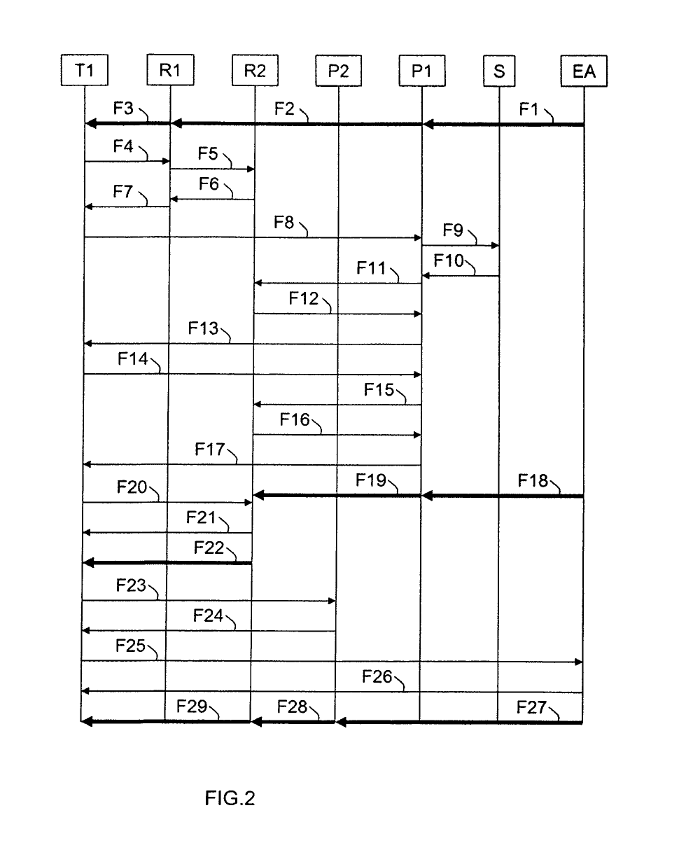

The method of the invention consists in a combination of four successive steps described in detail hereinafter with reference to FIG. 2.

In FIG. 2, the operations of the method begin at the arrow F4. The arrows F1 to F3 represent the transmission of packets coming from the second node T2 (downlink traffic), respectively between the home agent EA of the mobile first node T1 and the first anchor point P1 (F1), then from the first anchor point P1 to the first access router R1 (F2), and from the first access router R1 to the mobile first node T1 (F3).

In a first step i) (arrows F4 to F13), the (IP) address prefix of the second access router R2 is determined in order to communicate it to the mobile first node T1 in order for it to constitute therefrom additional local care-of addresses LCoA-2 and regional care-of addresses RCoA-2. Where appropriate it is also possible to determine the IP global address of the second anchor point P2 in order to communicate it to the first anchor point P1 if, as explained hereinafter, a tunnel is set up between two anchor points (although this IP global address information is in any event present because of the protocol used).

More precisely, it is preferably the mobile first node T1 that determines the network identifier of the second access equipment R2 that it has just detected. To this end, the mobile first node T1 can, for example, send (F4) the first access router R1 a Relocation-REQ type relocation request in order to inform it that it wishes to proceed to an access router handover. On receiving this request, the first access router F1 forwards it to the second access router R2 (F5). When the second access router R2 receives this Relocation-REQ type request, it generates a Relocation-RSP type response message to the first access router R1 (F6) containing its network identifier. On receiving this message, the first access router R1 forwards it to the mobile first node T1 (F7). These messages are radio messages exchanged between the mobile first node T1 and the access equipment and “level 2” messages (not IP messages) exchanged between the two access equipments (linked to the access technology, for example WIMAX). During this exchange, the mobile first node T1 informs the first access equipment R1 that it wishes to effect a handover to the second access equipment R2 (F4); this message contains the identifier of the second access equipment R2. The first and second access equipments R1, R2 then effect an exchange to confirm the handover (F5, F6) and the first access equipment R1 confirms the authorization to effect the handover (F7) to the mobile. It is important to note that this process of exchanging messages may vary as a function of the radio technology concerned, what is important here being for the mobile first node T1 to recover the identifier of the second access equipment R2.

Once the mobile first node T1 has the network identifier of the second access router R2, it forwards it to the first anchor point P1 (F8), for example by sending the first anchor point P1 a Router Solicitation for Proxy Advertisement (RtSoIPr) type message containing the network identifier that has been determined.

On receiving this RtSoIPr message, the first anchor point P1 determines on the one hand, from a server S of the network RIP, the IP global address that is associated with the network identifier that it contains (and which designates the second access router R2) and on the other hand, from the second access router R2, its address prefix.

To do this, the first anchor point P1 can, for example, send the server S (F9) a RequestIPAdd type IP global address search request containing the received network identifier. On receiving this request, the server S determines the IP global address that is associated with the received network identifier and then forwards that IP global address to the first anchor point P1 (F10). The first anchor point P1 can then send the second access router R2 (F11) a message requesting it to send its address prefix, for example by sending it a Remote Router Solicitation (RemoteRouterSol) type message. On receiving this message, the second access router R2 generates a response message of the Remote RA type, for example, to the first anchor point P1 (F12) containing its address prefix and its IP global address. On receiving the response message, the first anchor point P1 generates an advertisement message to the mobile first node T1 (F13) containing the address prefix of the second access router R2, for example by sending it a Proxy Router Advertisement (PrRtAdv) type message.

When the mobile first node T1 receives the address prefix of the second access router R2, it can then construct its additional local care-of address LCoA-2 and regional care-of address RCoA-2, for example using a stateless autoconfiguration procedure AutoConf.

In a second step ii) (arrows F14 to F17), the additional local care-of address LCoA-2 is communicated to the first anchor point P1 for it to set up a temporary tunnel TU (see FIG. 1) to the second access router R2 or the second anchor point P2. It can use the existing FMIPv6 protocol to do this. This temporary tunnel TU is intended to enable the first anchor point P1 to send packets coming from the second node T2 and addressed to the mobile first node T1 directly or indirectly to the second access router R2.

A temporary tunnel TU set up between the first anchor point P1 and the second access router R2 is considered hereinafter by way of nonlimiting illustrative example. However, a temporary tunnel could instead be set up between the first anchor point P1 and the second anchor point P2, subject to obvious adaptations to the operations described hereinafter.

For a temporary tunnel TU to be established between the first anchor point P1 and the second access router R2, the mobile first node T1 can, for example, generate a Fast Binding Update type message to the first anchor point P1 (F14) using FMIPv6 to construct the tunnel containing its additional local care-of address LCoA-2.

On receiving this Fast Binding Update message, the first anchor point P1 initiates a procedure with the second access router R2 for setting up a tunnel, for example by sending the second access router R2 (F15) a handover initiate type message. On receiving this message, the second access router R2 dedicates an input to the local care-of address LCoA-2 of the mobile first node T1 and sends the first anchor point P1 (F16) a Handover Ack type message to finalize the setting up of the temporary tunnel TU. Once the temporary tunnel TU has been set up, the first anchor point P1 can take the local care-of address LCoA-2 of the mobile first node T1 as its new local care-of address. It then responds to the Fast Binding Update message that it previously received from the mobile first node T1 (F14) by sending it a Fast Binding Ack type message (F17).

As shown in FIG. 2, at this stage, data packets that the first anchor point P1 receives from the home agent EA (F18) or has already received from the latter and are pending in a buffer can now be sent to the second access router R2 via the temporary tunnel TU (F19). However, they cannot yet be communicated to the mobile first node T1.

In a third step iii) (arrows F18 to F22), the mobile first node T1 is connected to the second access router R2 in order for the latter to forward to it data packets (or datagrams) that it receives (here directly) via the temporary tunnel TU.

To do this, the mobile first node T1 can, for example, connect to the second access router R2 by means of a network re-entry procedure. This is a real network re-entry since at this stage the connection between the mobile first node T1 and its first access router R1 has not yet been interrupted (this process is linked to the radio technology used, for example WiMAX, but is transparent as far as the invention is concerned). In this case, the mobile first node T1 sends the second access router R2 a Network Re-Entry-Req type request (F20). On receiving this request, the second access router R2 generates a Network Re-Entry-RSP type response message for the mobile first node T1 (F21) and proceeds to set up the connection with said mobile first node T1.

As shown in FIG. 2, at this stage the data packets that the second access router R2 had received from the home agent EA via the temporary tunnel TU (F18 and F19) and are pending in a buffer can now be forwarded to the mobile first node T1.

In a fourth step iv) (arrows F23 to F29), the local care-of address LCoA-2 and the regional care-of address RCoA-2 of the mobile first node T1 are first communicated to the second anchor point P2, after which the additional regional care-of address RCoA-2 of the mobile first node T1 is communicated to the home agent EA in order to substitute it for the previous one. The temporary tunnel TU is then finished with.

For example, the mobile first node T1 can send the second anchor point P2 (F23) a Local Binding Update type message containing its additional local care-of address LCoA-2 and regional care-of address RCoA-2 (the protocol used in this step is preferably HMIPv6). On receiving this message, the second anchor point P2 stores the additional local care-of address LCoA-2 and regional care-of address RCoA-2 in its database. It then generates a Binding Ack type message to the mobile first node T1 (F24) in order to inform it that it has stored them.

For example, the mobile first node T1 can then send its home agent EA (F25) a Binding Update message containing its additional regional care-of address RCoA-2. On receiving this message, the home agent EA updates its database, substituting the additional (and therefore new) regional care-of address RCoA-2 for the previous regional care-of address RCoA-1. It then generates a Binding Ack type message to the mobile first node T1 (F26) in order to inform it that it has stored its new regional care-of address RCoA-2.

This terminates handover in a macromobility situation. The temporary tunnel TU is eliminated and, as shown in FIG. 2, data packets coming from the second node T2 can be forwarded in the conventional way to the mobile first node T1 via the home agent EA (F27), the second anchor point P2 (F28), and the second access router R2 (F29).

To enable use of the method of the invention, the prior art mobility anchor point control module must be adapted. More precisely, the control module must be able, firstly, to temporarily support two additional local care-of addresses LCoA-1 and LCoA-2 and two additional regional care-of addresses RCoA-1 and RCoA-2 for the same mobile first node (this is possible under HMIPv6, for example), secondly, to store in a dedicated buffer data packets addressed to a mobile first node pending the setting up of a temporary tunnel and, thirdly, to initiate handover procedures in order to set up temporary tunnels with second access routers or other mobility anchor points. FMIPv6 defines the setting up of a tunnel between two access equipments in the micromobility context. Here a tunnel is constructed between an anchor point and an access equipment (or another anchor point) in the macromobility context and the invention proposes to do this by combining HMIPv6 and FMIPv6 in order to optimize handover.

The adapted mobility anchor point control module of the invention may take the form of electronic circuits, software (or electronic data processing) modules or a combination of circuits and software.

The invention is not limited to the call transfer method and mobility anchor point embodiments described above by way of example only and encompasses all variants that the person skilled in the art might envisage that fall within the scope of the following claims.

Thus certain radio exchanges (for example of “relocation” and “network re-entry” type) and certain exchanges between access equipments (for example those of “relocation” type) are described hereinabove in the context of a WiMAX radio access technology. However, other equivalent exchanges may be envisaged for other radio access technologies.

There is claimed:

1. A method of handing over a call involving at least one mobile equipment between radio access equipments of an Internet Protocol communication network using hierarchical routing and further comprising mobility anchor points and at least one agent equipment providing a home agent function, which method consists in effecting the following combination of steps when a mobile first equipment has set up an IP call to a second communication equipment via a home agent equipment of said mobile first equipment, a first anchor point and a first access equipment, and when said mobile first equipment when roaming detects a second access equipment connected to a second anchor point itself connected to said home agent equipment:
i) determining the address prefix of said second access equipment in order to communicate it to said mobile first equipment in order for the latter to construct additional local and regional care-of addresses from it,
ii) communicating said additional local care-of address to said first anchor point in order for it to set up a temporary tunnel to said second access equipment or said second anchor point in order to forward packets addressed to said mobile first equipment to said second access equipment,
iii) connecting said mobile first equipment to said second access equipment in order to send it said received packets via said temporary tunnel, and
iv) communicating said additional local and regional care-of addresses of the mobile first equipment to said second anchor point and then communicating said additional regional care-of address of the mobile first equipment to said home agent equipment in order for the latter to substitute it for the previous one.

2. A method according to claim 1, wherein in the step i) said mobile first equipment determines the network identifier of said second access equipment and then communicates that network identifier to said first anchor point in order for the latter to determine said associated IP global address of said second access equipment from a server of said network and then said address prefix of said second access equipment from the latter.

3. A method according to claim 2, wherein in the step i), before said mobile first equipment communicates the network identifier of said second access equipment to said first anchor point, said mobile first equipment informs said first access equipment that it wishes to handover the call to said second access equipment designated by its network identifier.

4. A method according to claim 3, wherein in the step i), after said mobile first equipment has informed said first access equipment that it wishes to handover the call to said second access equipment designated by its network identifier, said first access equipment informs said second access equipment of this handover requirement.

5. A method according to claim 1, wherein in the step i) said mobile first equipment constructs its additional local and regional care-of addresses by means of a stateless autoconfiguration procedure.

6. A method according to claim 1, wherein in the step ii) said mobile first equipment communicates its additional local care-of address to said first anchor point by means of a fast binding update type message.

7. A method according to claim 1, wherein in the step ii) said first anchor point and said second access equipment or said second anchor point set up said temporary tunnel by means of a handover procedure.

8. A method according to claim 1, wherein in the step ii) said first anchor point sends to said mobile first equipment a fast binding acknowledgement type message when said temporary tunnel has been set up.

9. A method according to claim 1, wherein in the step iii) said mobile first equipment connects to said second access equipment by means of a network re-entry procedure.

10. A method according to claim 1, wherein in the step iv) said mobile first equipment communicates its additional local and regional care-of addresses to said second anchor point by means of a local binding update type message after which said second anchor point sends to said mobile first equipment a Binding Acknowledgement message after updating the local and regional care-of addresses of the mobile first equipment to said additional local and regional care-of addresses.

11. A method according to claim 1, wherein in the step iv) said mobile first equipment communicates its additional regional care-of address to said home agent equipment by means of a Binding Update message, after which said home agent equipment sends to said mobile first equipment a Binding Acknowledgement message after updating the regional care-of address of the mobile first equipment to said additional regional care-of address.

12. A mobility anchor point for an Internet Protocol communication network using hierarchical routing, adapted to implement a portion of the handover method according to claim 1.

13. Use of the handover method and the mobility anchor point according to claim 1 in MIPv6 hierarchical routing communication networks.
